(19) United States
(12) Patent Application Publication
(10) Pub. No.: US 2020/0334721 A1
(43) Pub. Date: Oct. 22, 2020

(54) PROCESSING OF PRICING UPDATE DOCUMENTS

(71) Applicant: Anthony Zakula, Peachtree City, GA (US)

(72) Inventor: Anthony Zakula, Peachtree City, GA (US)

(21) Appl. No.: 16/917,093

(22) Filed: Jun. 30, 2020

Related U.S. Application Data
(63) Continuation-in-part of application No. 15/784,214, filed on Oct. 16, 2017, now Pat. No. 10,699,329.

(51) Int. Cl. G06Q 30/02; G06Q 10/08; G06Q 10/10; G06F 16/25; G06F 16/93; G06N 20/00; G06K 9/00

(52) U.S. Cl. CPC G06Q 30/0283; G06Q 10/087; G06Q 10/107; G06F 16/258; G06Q 10/0631; G06N 20/00; G06K 9/00463; G06K 9/00483; G06F 16/93

(57) ABSTRACT

Provided are methods and systems for processing pricing documents. An example method commences with receiving a pricing document and converting the pricing document into a text document. The method proceeds with identifying a plurality of regions that include text in the text document. The method further includes matching the text to a plurality of product data fields stored in records of a vendor and associated with a plurality of products. The plurality of product data fields store a first text value associated with a plurality of prices of the plurality of products. Based on the matching, at least one customer data field associated with one of the plurality of products is identified. The method includes identifying, in the at least one customer data field, a second text value that includes an updated price. The method further includes replacing, in the records, the first text value with the second text value.

### CROSS-REFERENCE TO RELATED APPLICATIONS

This application is a Continuation-in-Part of, and claims the priority benefit of, U.S. patent application Ser. No. 15/784,214, filed on Oct. 16, 2017, and entitled “Systems and Methods for Document to Order Conversion.” The subject matter of the aforementioned application is incorporated herein by reference in its entirety.

### TECHNICAL FIELD

The present application relates generally to data processing and, more specifically, to processing of pricing update documents.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A vendor can have a large number of product and service suppliers. Suppliers usually send pricing documents to the vendor. The pricing documents may be in a form of a spreadsheet that contains a list of products and/or services and prices of the product and/or services. The vendor may upload the product information provided by the suppliers and prices of the products into a financial record system of the vendor. The suppliers may periodically send pricing update documents to inform updated prices of the products to the vendor. Pricing update documents are often received in a Portable Document Format (PDF) or spreadsheet format and may contain thousands of products. The pricing update documents may be presented in a format convenient for the supplier, which rarely corresponds to a format used in the financial record system of the vendor. Therefore, upon receipt of the pricing update documents, the vendor needs to manually cross reference the products from the pricing update documents and the products in the financial record system and manually enter updated prices of products to the financial record system. However, manual processing of the pricing update documents and manual input of updated prices into the financial record system for a large number of products may be time- and resource-consuming.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure relates to systems and methods for processing pricing documents. According to one example embodiment of the present disclosure, a system for processing pricing documents is provided. The system can include a customer interface, a converting module, a processing module, and a data population module. The customer interface can be configured to receive a pricing document from a customer. The converting module can be configured to convert the pricing document into a text document. The processing module can be configured to identify, in the text document, a plurality of regions that include text. The processing module can also be configured to match one or more lines of the text of the plurality of regions to a plurality of product data fields. The plurality of product data fields may be stored in records of a vendor and may be associated with a plurality of products. The plurality of product data fields may store at least one first text value associated with a plurality of prices of the plurality of products. The processing module can also be configured to identify, based on the matching, in the one or more lines of the text, at least one customer data field. The at least one customer data field may be associated with one of the plurality of product data fields and one of the plurality of products. The processing module can also be configured to identify at least one second text value in the at least one customer data field. The at least one second text value may include an updated price of the one of the plurality of products. The data population module can be configured to replace, in the records of the vendor, the at least one first text value associated with the one of the plurality of products with the at least one second text value.

According to another example embodiment of the present disclosure, a method for processing pricing documents is provided. The method may include receiving a pricing document from a customer. The method can further include converting the pricing document into a text document. After the pricing document is converted, the method can proceed with identifying, in the text document, a plurality of regions that include text. The method can further include matching one or more lines of the text of the plurality of regions to a plurality of product data fields. The plurality of product data fields may be stored in records of a vendor and may be associated with a plurality of products. The plurality of product data fields may store at least one first text value associated with a plurality of prices of the plurality of products. Based on the matching, at least one customer data field may be identified in the one or more lines of the text. The at least one customer data field may be associated with one of the plurality of product data fields and one of the plurality of products. The method can further include identifying, in the at least one customer data field, at least one second text value. The at least one second text value may include an updated price of the one of the plurality of products. The method can further include replacing, in the records of the vendor, the at least one first text value associated with the one of the plurality of products with the at least one second text value.

According to yet another example embodiment of the present disclosure, the steps of the method for processing pricing documents are stored on a non-transitory machine-readable medium comprising instructions, which, when implemented by one or more processors, performs the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements and in which:

FIG. 1 shows an environment within which methods and systems for processing pricing documents can be implemented, according to an example embodiment.

FIG. 2 is block diagram illustrating a system for processing pricing documents, according to an example embodiment.

FIG. 3 is block diagram illustrating processing of a pricing document, according to an example embodiment.

FIG. 4 is a flow chart showing steps of a method for processing pricing documents, according to an example embodiment.

FIG. 5 is a diagrammatic representation of a computing device for a machine, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein can be implemented using a variety of technologies. For example, the methods described herein can be implemented in software executing on a computer system or in hardware utilizing either a combination of microprocessors or other specially designed application-specific integrated circuits, programmable logic devices, or various combinations thereof. In particular, the methods described herein can be implemented by a series of computer-executable instructions residing on a storage medium, such as a disk drive or computer-readable medium. It should be noted that methods disclosed herein can be implemented by a computer (e.g., a desktop computer, a tablet computer, a laptop computer), a cellular phone, a smart phone, a smart television system, and so forth.

As outlined in the summary, the embodiments of the present disclosure are directed to processing pricing documents. A vendor may have a plurality of suppliers, also referred herein to as customers. The vendor may receive, from the customers, information on products and prices of the products and store the product and price information in a financial record system associated with the vendor. The customers may periodically send pricing updates to the vendor to inform updated prices of the products. For example, a customer may upload a pricing document to a vendor website or a vendor portal, or send a pricing document to the vendor via email. The customer may provide the pricing document generated by a customer system using, for example, a document generated by the customer quote request system, a spreadsheet template, and so forth. The generated pricing update document can be in any format (for example, Hypertext Markup Language (HTML) format, PDF, image format, spreadsheet format, text format, and so forth).

A system for processing pricing documents of the vendor can be communicatively coupled to the website of the vendor in order to receive pricing documents. Upon receipt of the pricing document, the system for processing pricing documents can automatically process the pricing document and update the prices of products in the financial record system of the vendor. Specifically, the system can recognize data in the pricing document and convert the recognized data into a text document. Upon converting the pricing document into the text document, the system can identify a plurality of regions that include text in the text document.

Upon identifying the plurality of regions that include text, the system can auto-match recognized regions of text from the pricing document to records stored in a database of the vendor. Specifically, the system may match one or more lines of the text to a plurality of product data fields stored in records of the vendor. The product data fields stored in records of the vendor may be associated with a plurality of products of the vendor and may store product description data and first text values associated with prices of the plurality of products.

Upon a successful match, the system can identify, in the one or more lines of the text, at least one customer data field. Specifically, if based on the match it is determined that at least a portion of the text of the pricing document matches or corresponds to the information stored in the records of the vendor, the system determines that the portion of the text relates to one of the products for which information is present in the records of the vendor. Therefore, upon finding a match, the system determines that the one or more lines of the text include a customer data field related to one of the products. Furthermore, based on the match, the system identifies, in the records of the vendor, a product data field that stores the information related to this product. The product data field may store the information related to the product in a vendor format.

Upon determining the customer data field in the text document, the system identifies a second text value in the customer data field. The second text value may include an updated price of the product. In an example embodiment, the customer data field further include the product information in a customer format. Upon identifying the second text value, the system may replace, in the records of the vendor, the first text value associated with the product with the second text value identified in the customer data field of the text document. Therefore, by replacing the first text value with the second text value, the system replaces the price of the product stored in the product data field in the records of the vendor with an updated price identified in the customer data field provided in the pricing document by the customer.

In some example embodiments, the system may be unable to recognize some regions in the pricing document. This can occur when the system cannot identify a portion of the document as text. For example, the system may be unfamiliar with the format of the document. If the system is unable to recognize some regions in the pricing document, the system can request that the customer manually input data associated with the product corresponding to the unrecognized regions. The requested data may include the product information and the updated price of the product. Upon receiving the input, the system may match the product information entered by the customer to product information stored in the records, search the records to find the product data field that corresponds to the product information, and store the updated price to the product data field associated with the product in the records.

Furthermore, in some example embodiments, the system can be specifically trained to recognize documents provided by the customer. The customer can provide one or more pricing documents to the system of the vendor (for example, pricing documents in any format that the customer uses, for example, an image format, PDF format, spreadsheet format, and the like). The system can then convert the pricing documents into text documents and identify information related to products in the records of the vendor. Then, the system can notify the customer that some of the regions in the pricing document were not recognized and prompt the customer to manually input data related to the products and/or prices in the unrecognized regions.

The system can then store the relationship between the unrecognized regions and the product description and/or price provided by the customer into a database. If a further pricing document is received from the customer, the system can recognize the region of the same type as the previously unrecognized region and identify the product and/or the price based on the matching information in the database. Therefore, after receipt and recognition of several unrecognizable documents and corresponding manual input from the customer, the system can be trained to recognize all documents received from the customer, without further need for manual input. Thus, the system can be trained for each specific customer based on documents and manual input received from that specific customer.

Thus, the system for processing pricing documents can enable uploading a document in any format directly to the website of the vendor without the need for manual processing and entry of the product information and price information. Therefore, price processing time can be considerably reduced. Manual input may be requested by the system only when regions in the document of the customer cannot be recognized by the system. Once these documents are recognized, subsequent documents in the same format can be recognized using relationships stored in the database. Therefore, the customer is no longer required to provide input associated with the same unrecognizable regions in subsequent documents. Using the updated prices, an updated pricing document can be generated by the system of the vendor. The updated pricing document may include a list of products provided by the customer for sale and corresponding updated prices of the products. The updated pricing document can be in a format compatible with the system of records of the vendor. In an example embodiment, the system may generate the updated pricing document in a format of the vendor and then update the records in the database of the vendor based on the updated pricing document.

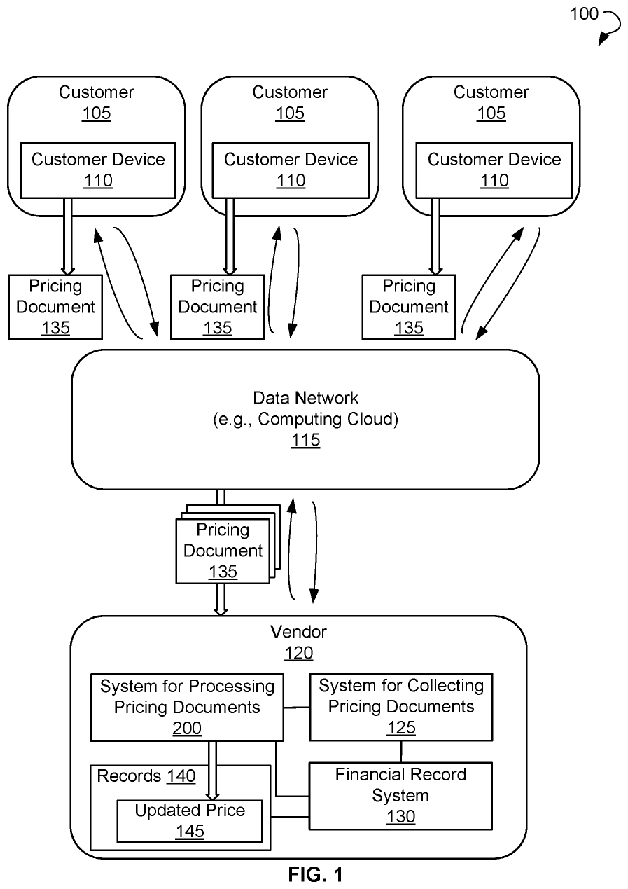

Referring now to the drawings, FIG. 1 illustrates an environment 100 within which methods and system for processing pricing documents can be implemented. The environment 100 can include one or more customer device(s) 110 associated with customer(s) 105. The environment 100 can further include a data network 115, a vendor 120, and a system 200 for processing pricing documents associated with the vendor 120. The system 200 for processing pricing documents is also referred herein to as a pricing processing system. The vendor 120 can further have a system of records, shown as a financial record system 130.

In some embodiments, the customer(s) 105 can be a person or company that may desire to supply products and/or services to the vendor 120. The customer(s) 105 can use one or more customer device(s) 110. The customer device(s) 110 can be any device available for use by the customer(s) 105, such as a smartphone, a tablet computer, a laptop computer, a desktop computer, and so forth. In certain embodiments, the customer(s) 105 can use the customer device(s) 110 to access the data network 115, for example, by using a web browser running on the customer device(s) 110. The customer(s) 105 can provide a pricing document 135 to the vendor 120 via the data network 115 and using the customer device 110.

The data network 115 can include the Internet, a computing cloud, and any other network capable of communicating data between devices. Suitable networks can include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications can also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking. The data network can include a network of data processing nodes, also referred to as network nodes, that are interconnected for the purpose of data communication.

The systems and methods described herein can also be practiced in a wide variety of network environments (represented by the data network 115) including, for example, Transmission Control Protocol/Internet Protocol-based networks, telecommunications networks, wireless networks, and the like. In addition, the computer program instructions can be stored in any type of computer-readable media. The program can be executed according to a variety of computing models including a client/server model, a peer-to-peer model, on a stand-alone computing device, or according to a distributed computing model in which various functionalities described herein can be effected or employed at different locations.

In some embodiments, the data network 115 being the computing cloud can include computing resources (hardware and software) available at a remote location and accessible over a network (for example, the Internet). The computing cloud can be shared by multiple users and can be dynamically re-allocated based on demand. The computing cloud can include one or more server farms/clusters including a collection of computer servers which can be co-located with network switches and/or routers. In various embodiments, the customer device(s) 110 and the vendor 120 can be connected to the computing cloud via one or more wireless network(s).

In various embodiments, the vendor 120 can include a person or an entity that receives products and/or services from suppliers, such as customer(s) 105, and provides the products and/or the services for sale. The vendor 120 can have a system 125 for collecting pricing documents (for example, a website of the vendor 120 on which the customer(s) 105 can upload pricing document 135). The system 125 for collecting pricing documents can be connected to the system 200 for processing pricing documents. The system 125 for collecting pricing documents and the system 200 for processing pricing documents of the vendor 120 can also be connected to a financial record system 130 of the vendor. The financial record system 130 can be a system of records responsible for collecting data from multiple sources, processing the data, and presenting the data for use by the vendor 120. In an example embodiment, the financial record system 130 can store data related to products and services provided by the vendor 120, such as prices, delivery of products and services, customers, and so forth. The system 200 for processing pricing documents may process pricing documents 135 provided by the customer(s) 105 and update prices of products in records 140 of the financial record system 130 of the vendor 120 to obtain updated prices 145 in the records 140.

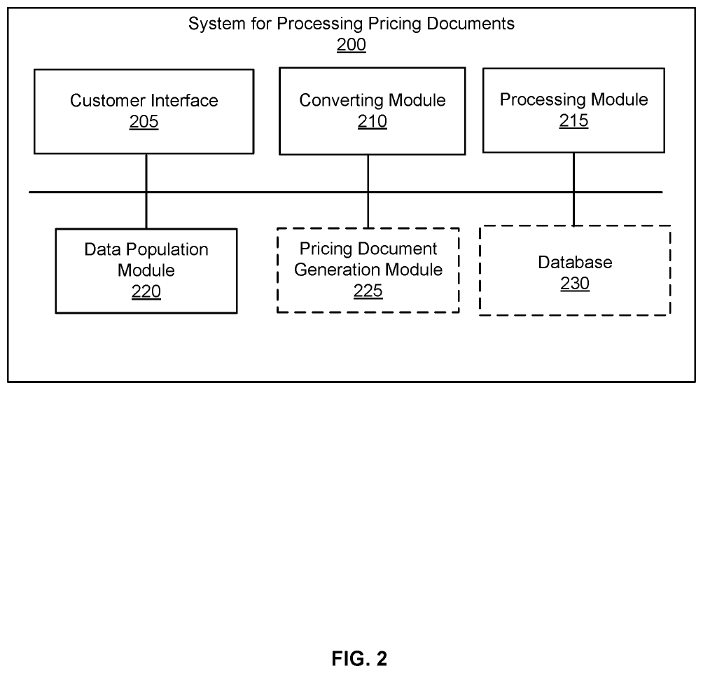

FIG. 2 is a block diagram showing a system 200 for processing pricing documents, according to an example embodiment. The system 200 can include a customer interface 205, a converting module 210, a processing module 215, a data population module 220, and optionally a pricing document generation module 225 and a database 230. The system 200 can also include additional or other components necessary for operations of system 200 for processing pricing documents. In other embodiments, the system 200 can include fewer components that can perform similar or equivalent functions to those depicted in FIG. 2.

The customer interface 205 can be configured to receive pricing documents from a customer via the data network 115. In some embodiments, the customer interface 205 can be associated with a website of a vendor. The website can have a document upload function that the customer can use to upload the pricing documents of the customer to the website. In an example embodiment, the customer interface 205 can be further configured to facilitate a manual upload of the pricing documents to the website and facilitate receipt of the pricing documents from the user via email.

The converting module 210 can be configured to convert the pricing document received via the customer interface 205 into a text document. In example embodiments, the converting module 210 can include an Optical Character Recognition (OCR) software tool, a scanner, and so forth. The converting module 210 can read the pricing document, recognize the text in the pricing document, and generate the text document based on the recognized text.

The processing module 215 can include hardware and/or software and can be configured to analyze the text document in order to identify a plurality of regions that include text in the text document. The processing module 215 can be configured to match one or more lines of the text of the plurality of regions to product data fields stored in records of the vendor. The product data fields may be data fields that include data related to products of the vendor and stored in the system of records of the vendor. Specifically, each of the product data fields may store product information, such as a product code, and a first text value associated with a price of the product. Based on the matching, the processing module 215 may identify, in the one or more lines of the text, at least one customer data field that relates to one of the plurality of product data fields and one of the plurality of products of the vendor. Specifically, the processing module 215 can determine that the one or more lines of the text include information that at least partially matches the product information stored in the one of the plurality of product data fields of the vendor. Based on such determination, the processing module 215 can identify the one or more lines of the text to be the customer data field that contains the information related to the product.

The processing module 215 can identify, in the customer data field, a second text value. The second text value may include an updated price of the one of the plurality of products.

In an example embodiment, the processing module 215 can be configured to determine that one or more of the plurality of regions remain unidentified. Based on the determination, the processing module 215 can prompt the customer to manually match the unidentified regions to one of the product data fields. More specifically, several product data fields may be provided for selection by the customer so that the customer may select a product data field that corresponds to the product described in the unidentified regions.

In a further example embodiment, the customer can be prompted to manually input text associated with the one or more of the plurality of regions remaining unidentified (for example, via a customer interface 205). Based on the manual input of the customer, the processing module 215 can identify a further product data field in the records that corresponds to the information entered by the customer.

Additionally, based on such determination that the one or more lines of the text of one of the plurality of regions cannot be automatically matched to the plurality of product data fields, the processing module 215 can create at least one additional product data field and store data manually provided by the customer to the at least one additional product data field.

The data population module 220 can be configured to replace, in the records of the vendor, the first text value (i.e., the original price) associated with the product with the second text value (i.e., the updated price) associated with the product. In an example embodiment, the first text value and the second text value may be in a numeric format, text format, and any other format.

The pricing document generation module 225 can be configured to generate an updated pricing document. The updated pricing document may include at least one of the plurality of product data fields associated with the one of the plurality of products. The one of the plurality of product data fields may include at least the product information and the updated price of the one of the plurality of products. The data population module 220 can be further configured to insert the updated pricing document into a financial record system to provide updated pricing information to the vendor based on the updated pricing document. In an example embodiment, the financial record system can include one of an Enterprise Resource Planning (ERP) system, an accounting system, an order processing system, and so forth.

The database 230 can store at least one relationship associated with a manual match between the unidentified regions and the product data field. The processing module 215 can be trained based on the relationship to automatically recognize the unidentified regions.

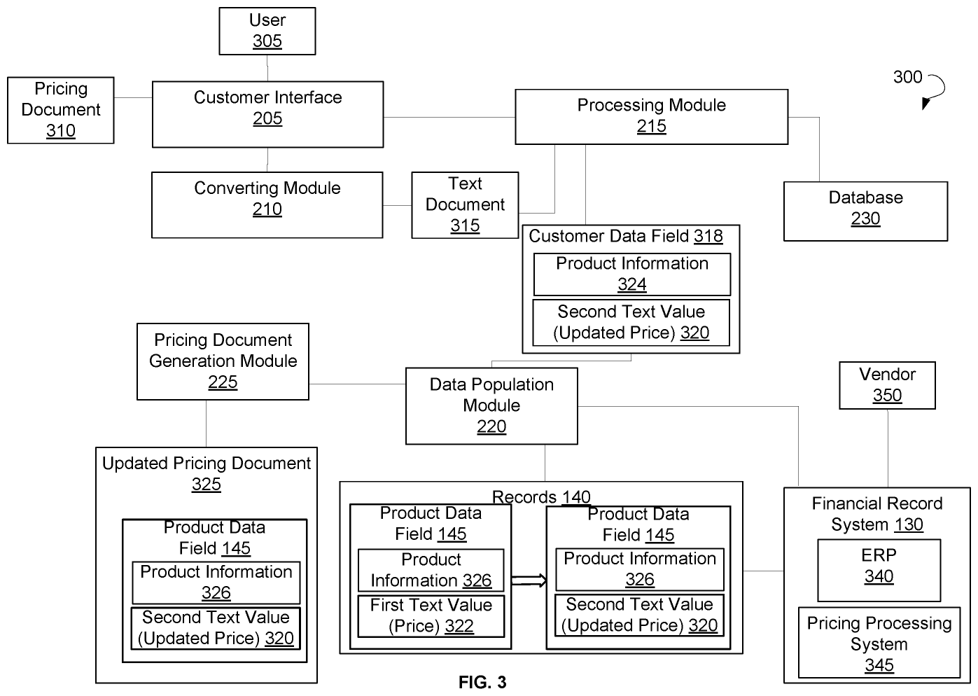

FIG. 3 is a block diagram 300 illustrating processing pricing documents. A user 305 can be a customer that wishes to supply products and/or services to a vendor 350 and sends updated prices of the products and/or services to the vendor 350. The user 305 can upload a pricing document 310 using a customer interface 205. For example, the user 305 can manually upload the pricing document 310 to a website via the customer interface 205. The pricing document 310 can be a spreadsheet file generated by a system of records of the user 305, a document generated by a quote request system of the user 305, an HTML file, a PDF file, an image file, and so forth. In some example embodiments, the user 305 can send the pricing document 310 to the vendor 350 via email. The vendor 350 can upload the pricing document 310 received via email for processing by a converting module 210.

The customer interface 205 can provide the pricing document 310 received from the user 305 to the converting module 210 for converting the pricing document 310 into a text document 315. The converting module 210 can parse the pricing document 310 and identify regions of patterns in the pricing document 310 that contain text. The processing module 215 can analyze the text document 315 by analyzing each line of the regions of patterns that contain text. Specifically, the processing module 215 can match one or more lines of the text of the plurality of regions to a plurality of product data fields 145 stored in records 140 of the vendor 350.

The records 140 may be associated with a financial record system 130 of the vendor 350. The records 140 may store information associated with a plurality of products of the vendor 350 in the form of product data fields 145. Each of the product data fields 145 may store a first text value 322 associated with a plurality of prices of the plurality of products. Furthermore, each of the product data fields 145 may store product information 326 relating to the products, such as product numbers, description, delivery information, and other product identification information. The product data fields 145 may store product information 326 in a format that is native to the financial record system 130 of the vendor 350. The product data fields 145 can have a specific format, for example, numeric format, text format, image format, or any other format configured to store the data associated with the products. In an example embodiment, the product data fields 145 can be stored in the database 230.

Based on the matching, the processing module 215 can identify at least one customer data field 318 in the one or more lines of the text. Specifically, the one or more lines of the text in the text document 315 may contain product information 324 relating to the description of the product. This product information 324 may be written in a format used by the customer, which may differ from the format of storing the product information 326 in the records 140 by the vendor 350. Therefore, based on the matching, the processing module 215 can determine that at least a portion of the product information 324 in the one or more lines of the text of the text document 315 matches or corresponds to at least a portion of the product information 326 stored in the product data fields 145.

Based on the determination that the one or more lines of the text of the text document 315 include product information 324 associated with one of the plurality of products of the vendor 350, the processing module 215 identifies the one or more lines of the text of the text document 315 to be the at least one customer data field 318. In an example embodiment, the processing module 215 can identify the at least one customer data field 318 based on the format of one or more lines of the text, type of data present in the one or more lines of the text, layout of the text document 315, and so forth. Therefore, the at least one customer data field 318 is associated with one of the plurality of products for which information is stored in one of the plurality of product data fields 145 in the records 140 of the vendor 350.

Upon identifying the at least one customer data field 318, the processing module 215 can identify at least one second text value 320 in the at least one customer data field. The at least one second text value 320 may include an updated price of the one of the plurality of products. In an example embodiment, the processing module 215 can determine metadata present in the one or more lines of the text. The metadata can include the second text value 320 present in the one or more lines of the text.

Upon identifying the at least one second text value 320, the processing module 215 can provide the second text value 320 to the data population module 220. The data population module 220 can replace, in the records 140 of the vendor 350, the first text value 322 associated with one of the plurality of products with the second text value 320. Specifically, the data population module 220 replaces the first text value 322 with the second text value 320 in the product data field 145.

In an example embodiment, the pricing document generation module 225 can generate an updated pricing document 325 for the vendor 350 based on the second text value 320 populated in the product data field 145. The updated pricing document 325 can include the product data field 145 that may contain the product information 326 and the second text value 320 (e.g., a product number related to the at least one product and an updated price of the at least one product). The pricing document generation module 225 may store the updated pricing document 325 into the financial record system 130.

In some embodiments, the processing module 215 can be unable to recognize one or more of the plurality of regions in the text document 315. The impossibility for the processing module 215 to recognize the one or more of the plurality of regions can be caused by the quality of the pricing document 310, specific format of the pricing document 310, specific symbols used by the user 305 in the pricing document 310, language of the pricing document 310, and so forth. Therefore, the processing module 215 can determine that one or more of the plurality of regions remain unidentified in the text document 315 and prompt the user 305 to manually input text associated with the one or more of the plurality of regions remaining unidentified.

Specifically, upon the prompt by the processing module 315, the user 305 can be presented a screen for manual input, by the user 305, of the text written in one or more of the plurality of regions of the text document 315. In an example embodiment, the user 305 can type product information and/or an updated price that were not recognized in the one or more of the plurality of regions of the text document 315. Based on the manual input of the product information and the updated price by the user 305, the processing module 215 may identify a further one of the plurality of product data fields 145 related to one of the plurality of products in the records 140.

In example embodiments, at least one relationship associated with the manual match between the unidentified regions and the further one of the plurality of product data fields in the records is stored to the database 230 as a match. The matches stored in the database 230 can be used to train the processing module 215 to automatically recognize the same or similar unidentified regions that can be present in further pricing documents of the user 305.

In example embodiments, the processing module 215 may be trained based on the manual input of the user to identify the unidentified regions of the pricing document. Based on the training, the processing module 215 may be configured to extract the text from the plurality of regions and identify the text automatically.

In an example embodiment, the processing module 215 may determine that the one or more lines of the text of one of the plurality of regions cannot be matched to the plurality of product data fields. Based on such determination, the processing module 215 may create at least one additional product data field in the records 140 and store the text of one of the plurality of regions that cannot be recognized in the additional product data field. Additionally, the processing module 215 can store the second text value manually inputted by the user 305 for the unrecognized plurality of regions. Therefore, the next time the user 305 submits a pricing document that contains regions that are identical or similar to the regions unrecognized in the first pricing document, the processing module 215 can find the matching product information and second text value related to the updated price of the product in the database 230. Specifically, the matching second text value is the second text value manually inputted by the user 305 during submission of the first pricing document shown as the pricing document 310.

Therefore, the system for processing pricing documents of the vendor 350 can be trained to recognize pricing documents of customers. The training can be performed by storing a match for an unrecognized region and product information and text values related to updated prices manually typed by the user 305. According to an example embodiment, the training can be performed by an artificial intelligence engine that can utilize statistical methods, computational intelligence, machine learning, mathematical optimization, logic methods, probability-based methods, and so forth.

In an example embodiment, the user 305 can submit a number of pricing documents to train the system for processing pricing documents of the vendor 350 to recognize pricing documents and derive product information and updated prices (i.e., text values) that correspond to products stored in the records of the vendor. For example, the user 305 can upload a plurality of pricing documents in all formats used by the user 305. The user 305 can be prompted to provide a manual input in respect to the regions of the text document that cannot be recognized. The match between the unrecognized regions and the product information and text values (i.e., updated prices) manually inputted by the user 305 is stored in the database 230 and is used for recognition for further pricing documents that may be provided later to the user 305. In some embodiments, the system for processing pricing documents of the vendor 350 can be trained to recognize all possible regions of pricing document 310. Therefore, after training of the system for processing pricing documents, the manual input of the user 305 may not be needed because all regions of the pricing documents can be successfully recognized by the system 200 for processing pricing documents of the vendor 350.

In some embodiments, the data population module 220 can insert the updated pricing document 325 into a financial record system 130 of the vendor 350. In some embodiments, the financial record system 130 can include an ERP system 340, an accounting system, a pricing processing system 345, and any other system used by the vendor 350 to manage pricing documents and store information on products and updated prices of the products. The updated pricing document 325 can have a format that is compatible with the financial record system 130 of the vendor 350.

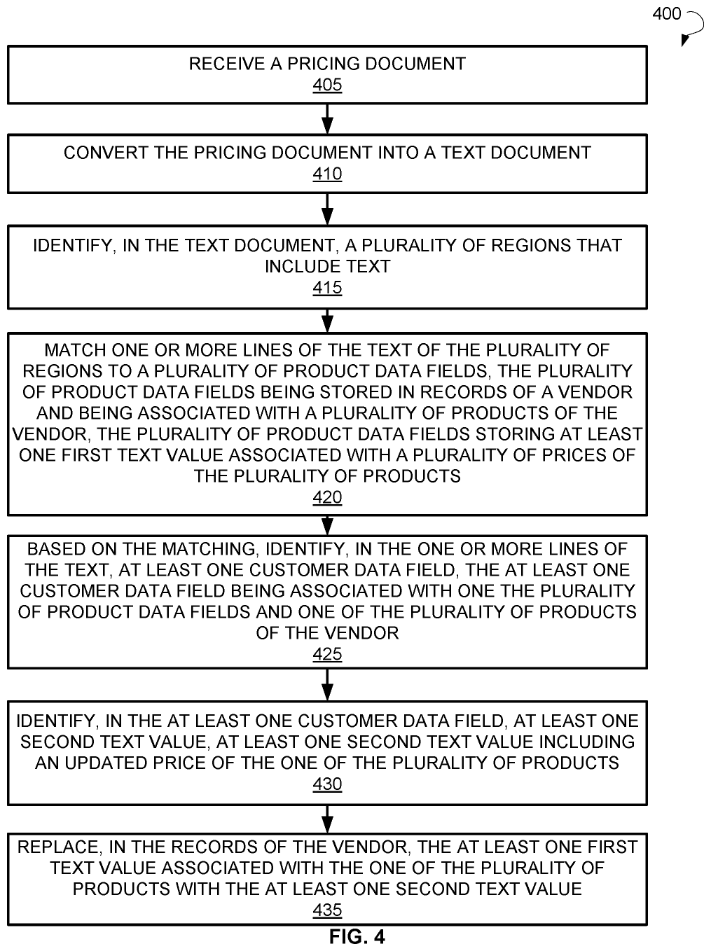

FIG. 4 is a flowchart showing steps of a method 400 for processing pricing documents, according to some example embodiments. The method 400 can be performed using components of the system 200 described in FIG. 2. The method 400 can commence with receiving, by a processor, a pricing document at step 405. In an example embodiment, the pricing document can be received based on a manual upload of the pricing document to a website by a user. In a further example embodiment, the pricing document can be received via email. The pricing document can include at least one of the following: an HTML file, a PDF file, an image file, a spreadsheet file, and so forth.

The method 400 can continue with converting the pricing document into a text document at step 410. The method 400 can further include identifying, in the text document, a plurality of regions that include text at step 415.

At step 420, the method 400 can include matching, by the processor, one or more lines of the text of the plurality of regions to a plurality of product data fields at step 420. The plurality of product data fields may be stored in records of a vendor and may be associated with a plurality of products for which information is stored in records of the vendor. The plurality of product data fields may store at least one first text value associated with a plurality of prices of the plurality of products.

The method can continue with identifying, based on the matching, in the one or more lines of the text, at least one customer data field at step 425. The at least one customer data field may be associated with one of the plurality of products for which information is stored in one of the plurality of product data fields in the records of the vendor.

At step 430, the method 400 can include identifying at least one second text value in the at least one customer data field. The at least one second text value may include an updated price of the one of the plurality of products.

At step 435, the method 400 can include replacing, in the records of the vendor, the at least one first text value associated with the one of the plurality of products with the at least one second text value.

Optionally, the method 400 may include generating an updated pricing document. The updated pricing document may include at least the one of the plurality of product data fields associated with the one of the plurality of products. The one of the plurality of product data fields may include at least the updated price of the one of the plurality of products.

The method 400 can further include storing the updated pricing document into a financial record system. The financial record system can be associated with the vendor and can store data related to products and prices. The financial record system includes one of an ERP, an accounting system, and an order processing system.

In an example embodiment, the method 400 can further include determining that one or more of the plurality of regions remain unidentified. Based on such determination, the user can be prompted to manually enter text associated with the one or more of the plurality of regions remaining unidentified (i.e., to manually input data present in the one or more of the plurality of regions). Based on the manual input of the customer, a further one of the plurality of product data fields may be identified in the records. The processor may be trained based on the manual input of the customer to identify the unidentified regions of the pricing document. Based on the training, the processor may extract the text from the plurality of regions and identify the text automatically.

In an example embodiment, the method 400 can further include storing, by the processor, at least one relationship associated with the manual match between the unidentified regions and the further one of the plurality of product data fields in the records. Based on the at least one relationship, the processor may be trained to automatically recognize the unidentified regions.

In a further example embodiment, the method 400 can include determining that the one or more lines of the text of one of the plurality of regions cannot be matched to the plurality of product data fields. Based on such determination, at least one additional product data field can be created. The data manually provided by the user can be stored in the additional product data field.

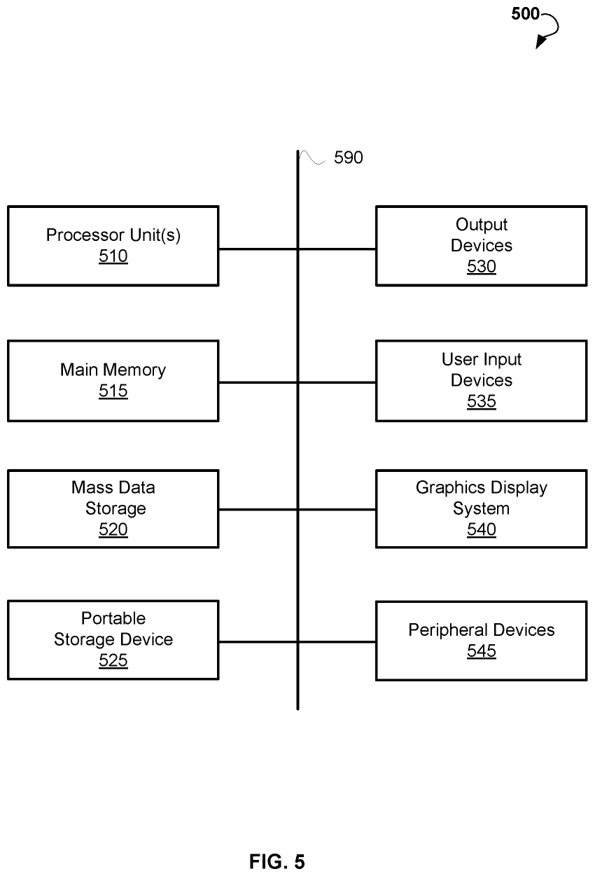

FIG. 5 illustrates an example computer system 500 that can be used to implement some embodiments of the present disclosure. The computer system 500 of FIG. 5 can be implemented in the contexts of the likes of computing systems, networks, servers, or combinations thereof. The computer system 500 of FIG. 5 includes one or more processor units 510 and main memory 515. Main memory 515 stores, in part, instructions and data for execution by processor units 510. Main memory 515 stores the executable code when in operation, in this example. The computer system 500 of FIG. 5 further includes a mass data storage 520, portable storage device 525, output devices 530, user input devices 535, a graphics display system 540, and peripheral devices 545.

The components shown in FIG. 5 are depicted as being connected via a single bus 590. The components can be connected through one or more data transport means. Processor unit 510 and main memory 515 are connected via a local microprocessor bus, and the mass data storage 520, peripheral device(s) 545, portable storage device 525, and graphics display system 540 are connected via one or more input/output (I/O) buses.

Mass data storage 520, which can be implemented with a magnetic disk drive, solid-state drive, or an optical disk drive, is a non-volatile storage device for storing data and instructions for use by processor unit 510. Mass data storage 520 stores the system software for implementing embodiments of the present disclosure for purposes of loading that software into main memory 515.

Portable storage device 525 operates in conjunction with a portable non-volatile storage medium, such as a flash drive, floppy disk, compact disk, digital video disc, or USB storage device, to input and output data and code to and from the computer system 500 of FIG. 5. The system software for implementing embodiments of the present disclosure is stored on such a portable medium and input to the computer system 500 via the portable storage device 525.

User input devices 535 can provide a portion of a user interface. User input devices 535 can include one or more microphones, an alphanumeric keypad, such as a keyboard, for inputting alphanumeric and other information, or a pointing device, such as a mouse, a trackball, stylus, or cursor direction keys. User input devices 535 can also include a touchscreen. Additionally, the computer system 500 as shown in FIG. 5 includes output devices 530. Suitable output devices 530 include speakers, printers, scanners, network interfaces, and monitors.

Graphics display system 540 includes a liquid crystal display (LCD) or other suitable display device. Graphics display system 540 is configurable to receive textual and graphical information and process the information for output to the display device.

Peripheral devices 545 can include any type of computer support device to add additional functionality to the computer system.

The components provided in the computer system 500 of FIG. 5 are those typically found in computer systems that can be suitable for use with embodiments of the present disclosure and are intended to represent a broad category of such computer components that are well known in the art. Thus, the computer system 500 of FIG. 5 can be a personal computer (PC), handheld computer system, telephone, mobile computer system, workstation, tablet, phablet, mobile phone, server, minicomputer, mainframe computer, wearable, or any other computer system. The computer can also include different bus configurations, networked platforms, multi-processor platforms, and the like. Various operating systems can be used including UNIX, LINUX, WINDOWS, MAC OS, PALM OS, QNX ANDROID, IOS, CHROME, TIZEN, and other suitable operating systems.

The processing for various embodiments can be implemented in software that is cloud-based. In some embodiments, the computer system 500 is implemented as a cloud-based computing environment, such as a virtual machine operating within a computing cloud. In other embodiments, the computer system 500 can itself include a cloud-based computing environment, where the functionalities of the computer system 500 are executed in a distributed fashion. Thus, the computer system 500, when configured as a computing cloud, can include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources can be utilized exclusively by their owners, or such systems can be accessible to outside users who deploy applications within the computing infrastructure to obtain the benefit of large computational or storage resources.

The cloud can be formed, for example, by a network of web servers that comprise a plurality of computing devices, such as the computer system 500, with each server (or at least a plurality thereof) providing processor and/or storage resources. These servers can manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus, methods and systems for processing pricing documents have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for processing pricing documents, the method comprising:
receiving, by a processor, a pricing document from a customer;
converting, by the processor, the pricing document into a text document;
identifying, by the processor, in the text document, a plurality of regions that include text;
matching, by the processor, one or more lines of the text of the plurality of regions to a plurality of product data fields, the plurality of product data fields being stored in records of a vendor and being associated with a plurality of products, the plurality of product data fields storing at least one first text value associated with a plurality of prices of the plurality of products;
based on the matching, identifying, by the processor, in the one or more lines of the text, at least one customer data field, the at least one customer data field being associated with one of the plurality of product data fields and one of the plurality of products;
identifying, by the processor, in the at least one customer data field, at least one second text value, the at least one second text value including an updated price of the one of the plurality of products; and
replacing, by the processor, in the records of the vendor, the at least one first text value associated with the one of the plurality of products with the at least one second text value.

2. The method of claim 1, further comprising:
determining, by the processor, that one or more of the plurality of regions remain unidentified;
prompting, by the processor, the customer to manually input text associated with the one or more of the plurality of regions remaining unidentified; and
based on the manual input of the customer, identifying a further one of the plurality of product data fields in the records.

3. The method of claim 2, further comprising:
training the processor based on the manual input of the customer to identify the unidentified regions of the pricing document; and
based on the training:
extracting the text from the plurality of regions; and
identifying the text automatically.

4. The method of claim 2, further comprising:
storing, by the processor, at least one relationship associated with the manual match between the unidentified regions and the further one of the plurality of product data fields in the records; and
based on the at least one relationship, training the processor to automatically recognize the unidentified regions.

5. The method of claim 3, further comprising:
determining, by the processor, that the one or more lines of the text of one of the plurality of regions cannot be matched to the plurality of product data fields; and
based on the determination, creating, by the processor, at least one additional product data field.

6. The method of claim 1, further comprising generating, by the processor, an updated pricing document, the updated pricing document including at least the one of the plurality of product data fields associated with the one of the plurality of products, the one of the plurality of product data fields including at least the updated price of the one of the plurality of products; and
storing the updated pricing document into a financial record system.

7. The method of claim 6, wherein the financial record system includes one of an Enterprise Resource Planning (ERP), an accounting system, and an order processing system.

8. The method of claim 1, wherein the receiving of the pricing document includes one of the following:
a manual upload of the pricing document to a website; and
receiving the pricing document via email.

9. The method of claim 1, wherein the pricing document includes at least one of the following: an Hypertext Markup Language (HTML) file, a Portable Document Format (PDF) file, an image file, and a spreadsheet file.

10. A system for processing pricing documents, the system comprising:
a customer interface configured to receive a pricing document associated with a customer;
a converting module configured to convert the pricing document into a text document; and
a processing module configured to:
identify, in the text document, a plurality of regions that include text;
match one or more lines of the text of the plurality of regions to a plurality of product data fields, the plurality of product data fields being stored in records of a vendor and being associated with a plurality of products, the plurality of product data fields storing at least one first text value associated with a plurality of prices of the plurality of products;
based on the matching, identify, in the one or more lines of the text, at least one customer data field, the at least one customer data field being associated with one of the plurality of product data fields and one of the plurality of products; and
identify, in the at least one customer data field, at least one second text value, the at least one second text value including an updated price of the one of the plurality of products; and
a data population module configured to replace, in the records of the vendor, the at least one first text value associated with the one of the plurality of products with the at least one second text value.

11. The system of claim 10, further comprising a pricing document generation module configured to generate an updated pricing document, the updated pricing document including at least the one of the plurality of product data fields associated with the one of the plurality of products, the one of the plurality of product data fields including at least the updated price of the one of the plurality of products.

12. The system of claim 11, wherein the data population module is further configured to store the updated pricing document into a financial record system to provide pricing information based on the updated pricing document.

13. The system of claim 12, wherein the financial record system includes one of an Enterprise Resource Planning (ERP), an accounting system and an order processing system.

14. The system of claim 10, wherein the processing module is further configured to:
determine that one or more of the plurality of regions remain unidentified;
prompt the customer to manually input text associated with the one or more of the plurality of regions remaining unidentified; and
based on the manual input of the customer, identify a further one of the plurality of product data fields in the records.

15. The system of claim 14, wherein the processing module is being trained based on the manual input of the customer to identify the unidentified regions of the pricing document;
wherein the processing module is further configured to, based on the training:
extract the text from the plurality of regions; and
identify the text automatically.

16. The system of claim 14, further comprising:
a database to store at least one relationship associated with the manual match between the unidentified regions and the further one of the plurality of product data fields in the records.

17. The system of claim 16, wherein the processing module is being trained, based on the at least one relationship, to automatically recognize the unidentified regions

18. The system of claim 10, wherein the processing module is further configured to:
determine that the one or more lines of the text of one of the plurality of regions cannot be matched to the plurality of product data fields; and
based on the determination, create at least one additional product data field.

19. The system of claim 10, wherein the customer interface is further configured to:
facilitate a manual upload of the pricing document to a website; and
facilitate receipt of the pricing document via email.

20. A non-transitory computer-readable storage medium having embodied thereon instructions, which when executed by at least one processor, perform steps of a method, the method comprising:
receiving, by a processor, a pricing document from a customer;
converting, by the processor, the pricing document into a text document;
identifying, by the processor, in the text document, a plurality of regions that include text;
matching, by the processor, one or more lines of the text of the plurality of regions to a plurality of product data fields, the plurality of product data fields being stored in records of a vendor and being associated with a plurality of products, the plurality of product data fields storing at least one first text value associated with a plurality of prices of the plurality of products;
based on the matching, identifying, by the processor, in the one or more lines of the text, at least one customer data field, the at least one customer data field being associated with one of the plurality of product data fields and one of the plurality of products;
determining, by the processor, that one or more of the plurality of regions remain unidentified;
prompting, by the processor, the customer to manually input text associated with the one or more of the plurality of regions remaining unidentified;
based on the manual input of the customer, identifying a further one of the plurality of product data fields in the records;
training the processor based on the manual input of the customer to identify the unidentified regions of the pricing document;
based on the training:
extracting the text from the plurality of regions; and
identifying the text automatically;
identifying, by the processor, in the at least one customer data field, at least one second text value, the at least one second text value including an updated price of the one of the plurality of products; and
replacing, by the processor, in the records of the vendor, the at least one first text value associated with the one of the plurality of products with the at least one second text value.
